(19) United States
(12) Patent Application Publication
(10) Pub. No.: US 2008/0080618 A1
(43) Pub. Date: Apr. 3, 2008

(54) Video decoding apparatus and method of the same

(76) Inventors: Kazuya Takagi, Osaka (JP); Takahiro Nishi, Nara (JP)

Correspondence Address: WENDEROTH, LIND & PONACK L.L.P., 2033 K. STREET, NW, SUITE 800, WASHINGTON, DC, 20006, US

(21) Appl. No.: 11/905,061

(22) Filed: Sep. 27, 2007

(30) Foreign Application Priority Data
Sep. 28, 2006 (JP) 2006-264039

(51) Int. Cl. H04B 1/66

(52) U.S. Cl. 375/240.16; 375/E07.105

(57) ABSTRACT

A video decoding apparatus which decodes a bitstream on an area-by-area basis. The area is included in a picture of an interlace format. The bitstream is coded by switching coding types between field coding and frame coding. The apparatus includes: a filter processing unit which performs post filtering for removing noise; a coding type identifying unit which identifies the coding type of a current area and further identifies the coding type of either the area contained in a picture temporally continuous to the current picture and colocated with the current area or the area spatially adjacent to the current area; and a noise removing strength determination unit which determines strength for removing noise according to whether the identified coding type is the frame coding or the field coding. The processing unit performs post filtering on the current area according to the noise removing strength.

### BACKGROUND OF THE INVENTION

(1) Field of the Invention

The present invention relates to a video decoding apparatus which decodes a compressed bitstream and a method of the same, and in particular to post filtering for reducing fluctuation of image quality in a temporal direction.

(2) Description of the Related Arts

There are widely used applications such as an application for distributing videos via Internet Protocol (IP) networks and an application for recording videos onto a storage medium including a Digital Versatile Disc (DVD) and a Blu-ray Disc (BD). In these applications, information is compressed and coded using video coding techniques in order to be distributed through a predetermined transmission band or to fall within a media capacity.

Videos are coded by removing spatial and temporal redundancy contained in the videos. Spatial redundancy is removed by intra picture prediction coding for coding a difference between a pixel value predicted from a value of an adjacent pixel which has been decoded and a current pixel value, by using a correlation between pixels. On the other hand, temporal redundancy is removed by inter picture prediction coding for coding a difference between a prediction picture generated by predicting motion from a decoded picture and a current picture, by using a correlation between pictures.

A coded video is made up of plural picture groups called Group Of Pictures (GOP) as shown in FIG. 1. An I picture positioned at the top of a GOP is coded using the intra picture prediction coding, and pictures following the I picture are coded by the inter picture prediction coding.

Note that, in the case where the current video is in an interlace format, it is possible to select a coding type from field coding and frame coding. As shown in FIG. 2, in the field coding, a top field and a bottom field are coded as independent pictures. While, in the frame coding, the top field and the bottom field are coded on a frame-by-frame basis. The frame consists of the top field and the bottom field.

Generally, in a scene where a frame correlation is greater than a field correlation, in other words, a scene where very little motion is present, frame coding is suitable. In a scene where the field correlation is greater than the frame correlation, in other words, a scene where motion is present, field coding is suitable. Consequently, when coding a current video, the frame coding is likely to be selected in an area including only a small amount of motion, and the field coding is likely to be selected in an area including a large amount of motion.

Further, coding can be switched between the field coding and the frame coding not only on a picture-by-picture basis, but also on a block-by-block basis where the block is a macroblock. In this case, two vertically adjacent macroblocks are processed as a pair, as shown in FIG. 3. In terms of coding efficiency, frame coding is suitable for a macroblock in which very little motion is present, and field coding is suitable for a macroblock in which motion is present, similarly to the case of coding on a picture-by-picture basis. The switching between the field coding and the frame coding needs to be controlled effectively to enhance the coding efficiency.

However, videos with high coding efficiency are not necessarily fine videos. A representative example for that is coding noise called pulsing noise (See PCSJ2005 Preliminary report “Detento tsuki ryoshika seigyo ni yoru I-pikucha furikka no teigen houhou” (A method for reducing an I picture flicker by a quantization control with a detent)). The pulsing noise occurs due to the image quality of an I picture.

As described above, the I picture is coded within a picture without referring to other pictures. For that reason, the I picture lacks consistency of an image quality between pictures. Consequently, the image quality fluctuates in a temporal direction at the I picture which is positioned at the top in a GOP, causing visual deterioration. Especially in the applications where random accessibility is required for image searching and compiling, all the pictures are coded within a picture without referring to other pictures. In this case, the image quality fluctuates in all the pictures. For that reason, flicker noise which causes more deterioration than pulsing noise is generated (See Japanese Unexamined Patent Application Publication NO. 2005-323315, Japanese Unexamined Patent Application Publication NO. 2005-20771 and PCSJ2005 Preliminary report “H. 264/MPEG-4 AVC ni okeru intora fugoka furemu no furikka teigen hoho” (A method for reducing a flicker of an intra coding frame under H. 264/MPEG-4 AVC)).

As described above, it is necessary to establish a coding method in consideration not only of coding efficiency, but also of visual quality. However, there is no method established for reducing pulsing noise and flicker noise completely on the coding processing side.

It is therefore necessary to reduce the coding noise by post filtering on the decoding processing side. By performing post filtering, the consistency of image quality in the temporal direction can be enhanced, thereby reducing above described noise and the like.

More specifically, a smoothing filter which is represented by the following expression 1 is applied, where a frame index is t, an output picture is o(t), a decoded picture is p(t) and a noise removing strength is W (0 indicating low strength and 1 indicating high strength).

o(t)=(1−W)×p(t)+W×o(t−1) (Expression 1)

### In this case, the noise removing strength W needs to be determined according to the presence or absence of motion, since residual images occur when the noise removing strength W is increased on an area in which motion is present.

In order to detect the presence or absence of motion, however, it is necessary to calculate inter-picture difference and the like, causing a problem of increased processing amount. It is therefore presented a method that uses a motion vector obtained through decoding processing when a compressed bitstream is inputted (See Japanese Unexamined Patent Application Publication NO. 2002-171424). However, the I picture which is a main cause of the fluctuation in image quality does not have a motion vector. Accordingly, the method which utilizes a motion vector can not be applied to the I picture.

It is also presented a method of detecting motion of a picture by referring to a coding type (See Japanese Unexamined Patent Application Publication NO. 2004-104171). As described above, the field coding is likely to be selected as the coding type for an area where motion is present, and the frame coding is likely to be selected as the coding type for an area where very little motion is present. In other words, by detecting the coding type for the area, it is possible to detect whether it is an area where motion is present or an area where very little motion is present. Accordingly, this method may be considered for removing noise in an I picture which has no motion vector, selectively between an area where motion is present and an area where very little motion is present.

However, the technique disclosed in Japanese Unexamined Patent Application Publication NO. 2004-104171 has a disadvantage that the coding type does not strictly correspond to the presence or absence of motion. In other words, the frame coding is not always selected when coding an area, just because no motion is present in the area. Likewise, the field coding is not always selected when coding an area, just because motion is present in the area. Accordingly, when post filtering is performed with greater noise removing strength just because the coding type is the frame coding, there is a risk that post filtering may be performed on even an area in which motion is present. In this case, residual images occur in the area in which motion is present, and the visual image quality is deteriorated.

### SUMMARY OF THE INVENTION

The present invention has been conceived in view of the above-described problem. The invention aims to provide a video decoding apparatus and a method of the same which prevents performing post filtering with great removing strength on an area in which motion is present, by enhancing accuracy in judging the presence or absence of motion.

The video decoding apparatus of the present invention decodes a bitstream on an area-by-area basis. The area is included in a picture of an interlace format. The bitstream is coded by switching coding types between: field coding in which a top field and a bottom field are coded independently; and frame coding in which the top field and the bottom field are coded on a frame-by-frame basis. The frame consists of the top field and the bottom field. The apparatus includes: a filter processing unit which performs post filtering that removes noise of a decoded picture; a coding type identifying unit which identifies a coding type of a current area on which post filtering is performed, and one of: a coding type of an area which is included in a picture temporally continuous to a current picture and which is colocated with the current area of the current picture; and a coding type of an area spatially adjacent to the current area; and a noise removing strength determination unit which determines noise removing strength for the post filtering depending on whether the coding type identified by said coding type identifying unit is the frame coding or the field coding. The filter processing unit performs post filtering on the current area according to the noise removing strength.

With this structure, the coding type is identified not only for a current area of noise removing processing, but also for other areas, resulting in an accurate judgment of the presence or absence of motion for the current area. Accordingly, it is possible to prevent performing the post filtering with great strength on an area in which motion is present.

Further, the coding type identifying unit may identify the coding type of an area which is included in each of the plurality of pictures temporally continuous from the current picture and is colocated with the current area of the current picture. The noise removing strength determination unit may, in a case where the coding type of the current area is the frame coding, set a greater noise removing strength for the post filtering, as more pictures which are temporally continuous from the current picture include areas whose coding types are identified, by said coding type identifying unit, as the frame coding.

With this structure, the more continuous pictures include areas where the coding type is the frame coding, the greater strength of the noise removing filter may be applied. In other words, the strength of the noise removing filter can be set greater for the area where it is more certain that motion is not present. Accordingly, it is possible to remove noticeable noise in the area in which very little motion is present, while protecting motion of inputted images as much as possible.

Furthermore, the coding type identifying unit may identify the coding type of each of the plurality of areas spatially adjacent to the current area. The noise removing strength determination unit may, in a case where the coding type of the current area is the frame coding, set a greater noise removing strength for the post filtering, as there are more areas whose coding types are identified, by said coding type identifying unit, as the frame coding.

With this structure, the more blocks whose coding types are the frame coding present around, the greater strength of the noise removing filter can be applied. In other words, the strength of the noise removing filter can be set greater for the area where it is more certain that motion is not present. Accordingly, it is possible to remove noticeable noise in the area where very little motion is present, while protecting motion of inputted images as much as possible. Further, the noise removing strength determination unit may, in a case where a quantization parameter for the current area is less than a predetermined threshold, set the noise removing strength as 0. The filter processing unit may, in a case where the noise removing strength is 0, prevent the post filtering from being performed on the current area.

With this structure, in the case where a quantization parameter indicates less than a certain threshold, it is not necessary to confirm temporal continuity or spatial correlation, resulting in a reduced processing amount. Further, the quantization parameter is a parameter obtained as a result of decoding a bitstream. Accordingly, additional processing amount for detecting the quantization parameter is not required.

Furthermore, the noise removing strength determination unit may, in a case where the quantization parameter is equal to or more than the threshold, set the greater noise removing strength for the post filtering, as the quantization parameter becomes greater.

With this structure, a value of the noise removing strength can be determined adaptively, according to the value of the quantization parameter. To what degree noise is noticeable differs according to a bit rate. Consequently, deterioration of image quality, which is caused by performing filtering with unnecessarily great strength, can be prevented from occurring.

The video decoding apparatus and the method of the same according to the present invention can suppress the occurrence of residual images by judging accurately the presence or absence of motion, and preventing performing post filtering with great strength on an area in which motion is present. Further, post filtering can be performed with low processing amount, and also be applied to the I picture which includes no motion vector.

### FURTHER INFORMATION ABOUT TECHNICAL BACKGROUND TO THIS APPLICATION

The disclosure of Japanese Patent Application No. 2006-264039 field on Sep. 28, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the Drawings:

FIG. 1 shows a structure of GOP;

FIG. 2 shows a structure of a picture in field coding;

FIG. 3 shows a macroblock at which switching between the field coding and the frame coding can be performed;

FIG. 4 is a functional block diagram according to an video decoding apparatus of the present invention;

FIG. 5 is a functional block diagram according to a video decoding unit of the video decoding apparatus of the present invention;

FIG. 6 shows a coding parameter indicating a coding type of H. 264/AVC;

FIG. 7 shows macroblock addresses and coding types associated one-to-one with the macroblock addresses;

FIG. 8 is a functional block diagram according to a noise removing unit of the video decoding apparatus of the present invention;

FIG. 9 shows a relation between a quantization step Qs and a strength Wq;

FIG. 10 shows an example of computation of the strength Wt;

FIG. 11 shows an example of computation of the strength Ws;

FIG. 12A is a flowchart showing an operation of the video decoding apparatus of the present invention;

FIG. 12B is a flowchart showing an operation of a determining processing of the strength Wt;

FIG. 12C is a flowchart showing an operation of a determining processing of the strength Ws;

FIG. 13 shows an example of determining processing of the strength Wt;

FIG. 14 spatially shows the determining processing of the strength Wt;

FIG. 15 shows an example of determining processing of the strength Ws; and

FIG. 16 spatially shows the determining processing of the strength Ws.

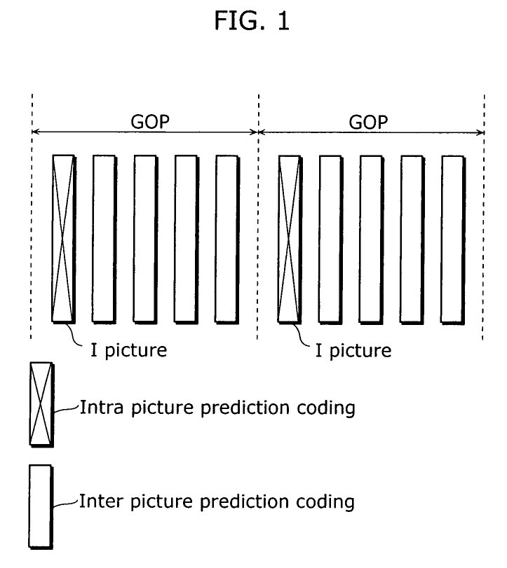

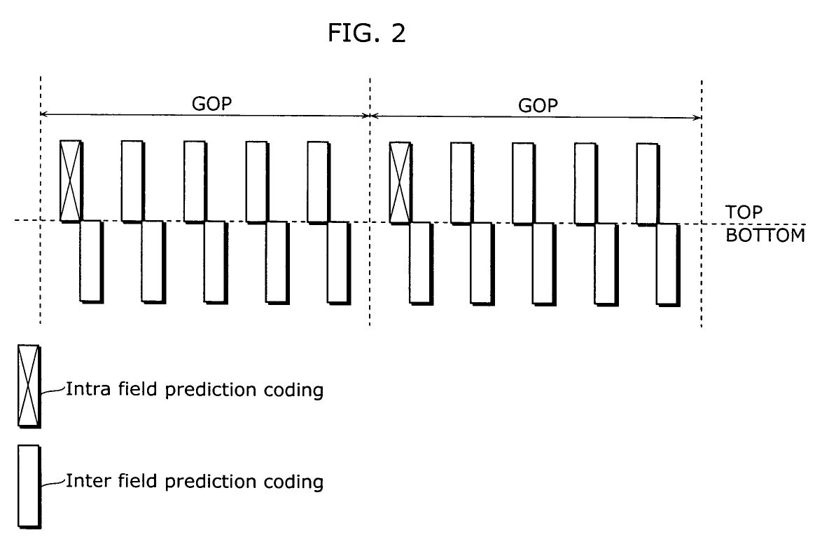

### DESCRIPTION OF THE PREFERRED EMBODIMENT

Embodiments according to the present invention will be described in detail below with reference to the drawings.

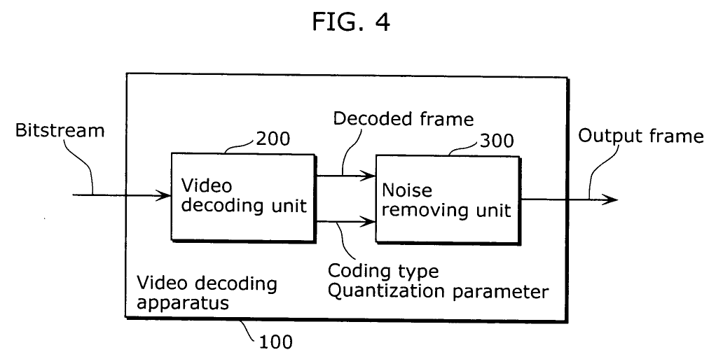

FIG. 4 shows functional blocks of a video decoding apparatus 100 of the present embodiment.

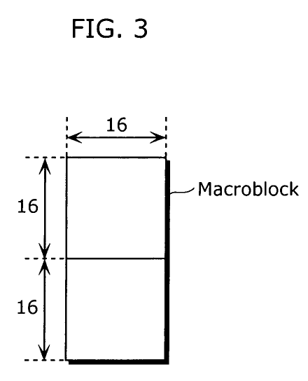

The video decoding apparatus 100 of this embodiment decodes a compressed bitstream and removes coding noise, before outputting the bitstream as an output frame. In this embodiment, decoding processing, determination processing for a noise removing strength, and post filtering are performed on a block-by-block basis as shown in FIG. 3.

The video decoding apparatus 100 includes, as structural elements, a video decoding unit 200 which decodes a bitstream and a noise removing unit 300 which removes coding noise.

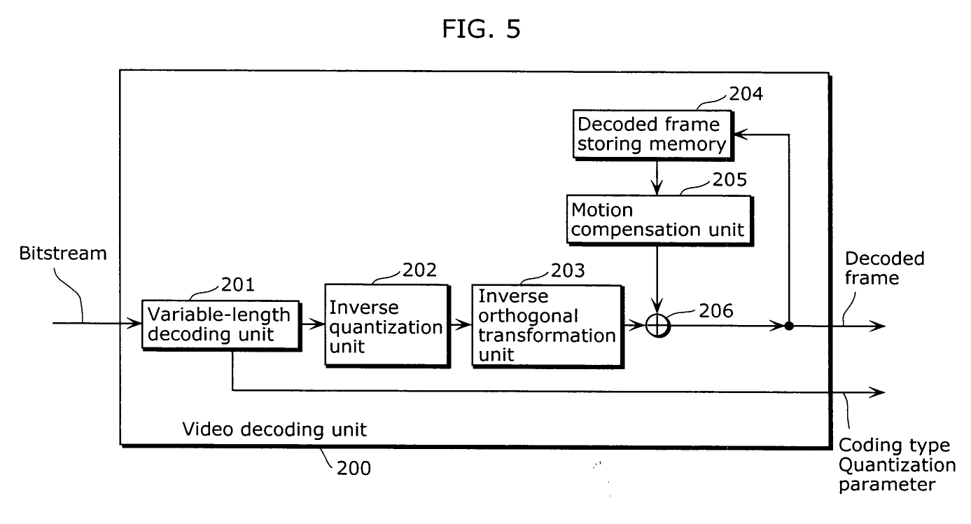

FIG. 5 shows functional blocks of the video decoding unit 200 which makes up the video decoding apparatus 100.

The video decoding unit 200 decodes a compressed bitstream and transfers a decoded frame, a coding type, and a quantization parameter to the noise removing unit 300.

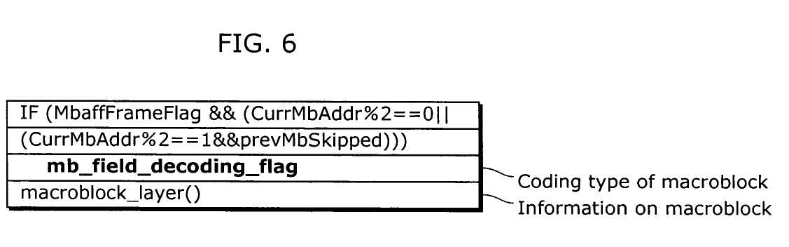

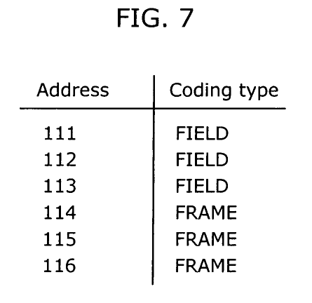

Here, the coding type is one of coding parameters which indicates whether a current area for coding is coded by the field or by the frame. Under H. 264/AVC which is a standard for a compression of videos, the coding type is described as a parameter called mb_field_decoding_flag, as shown in FIG. 6, and can be designated on a macroblock-by-macroblock basis.

The value of the quantization parameter runs from 0 to 51 in the case of H. 264/AVC. It indicates that the coding has been performed at higher bit rate, as the value approaches 0. When the area is coded with a high bit rate, smoothing processing in a temporal direction is not required, since the noise is not noticeable.

The video decoding unit 200 includes, as structural elements, a variable-length decoding unit 201, an inverse quantization unit 202, an inverse orthogonal transformation unit 203, a decoded frame storing memory 204, a motion compensation unit 205, and an adder 206.

The variable-length decoding unit 201 is a processing unit which performs a variable-length decoding on a bitstream. The variable-length decoding unit 201 decodes a bitstream to obtain a coding parameter including a quantization parameter, a motion vector, a coding type and the like, and an orthogonal transformation coefficient. Parameters related to motion compensation such as a motion vector are transferred to the motion compensation unit 205. Parameters related to quantization such as a quantization parameter and an orthogonal transformation coefficient are transferred to the inverse quantization unit 202. Further, the coding type is transferred to the noise removing unit 300 by the frame in association with a macroblock address. Likewise, a quantization parameter is transferred to the noise removing unit 300.

The inverse quantization unit 202 is a processing unit which performs inverse quantization on the orthogonal transformation coefficient. The inverse quantization unit 202 performs inverse quantization on the orthogonal transformation coefficient by using the quantization parameter transferred by the variable-length decoding unit 201 and the quantized orthogonal transformation coefficient. Then, the inversely quantized orthogonal transformation coefficient is transferred to the inverse orthogonal transformation unit 203.

The inverse orthogonal transformation unit 203 is a processing unit which performs inverse orthogonal transformation on the inversely quantized orthogonal transformation coefficient. The inverse orthogonal transformation unit 203 obtains a prediction error by performing inverse orthogonal transformation on the orthogonal transformation coefficient transferred from the inverse quantization unit 202, and then transfers the prediction error to the adder 206.

The decoded frame storing memory 204 is a storage unit which temporarily stores the decoded frame.

The motion compensation unit 205 is a processing unit which performs motion compensation using a reference frame. The motion compensation unit 205 obtains a decoded frame from the decoded frame storing memory 204, performs motion compensation by using a motion vector transferred by the variable-length decoding unit 201 and a prediction mode, and then generates a prediction frame. The generated prediction frame is transferred to the adder 206.

The adder 206 adds the prediction frame and a prediction error. The adder 206 transfers, to the noise removing unit 300, the decoded frame which is obtained by adding the prediction error transferred from the inverse orthogonal transformation unit 203 to the prediction frame transferred from the motion compensation unit 205.

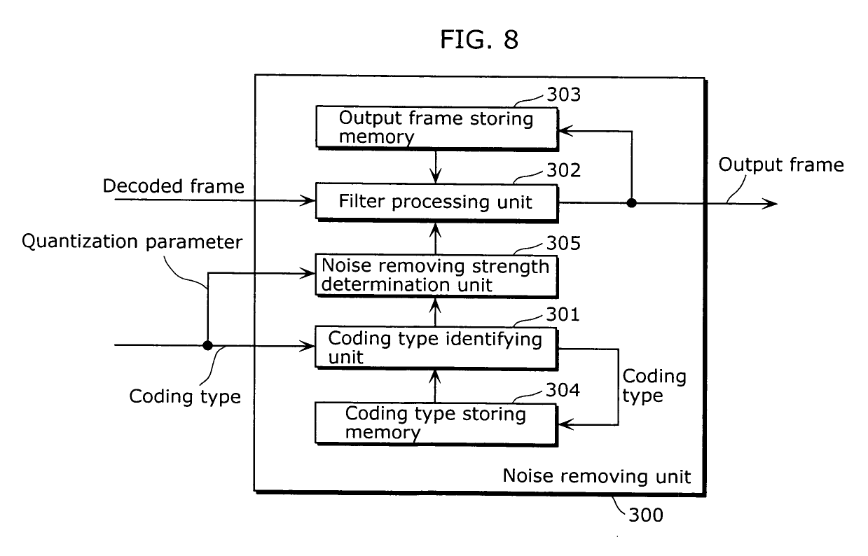

FIG. 8 shows functional blocks of the noise removing unit 300 which makes up the video decoding apparatus 100.

The noise removing unit 300 reduces coding noise of the decoded frame transferred from the video decoding unit 200 according to the coding type, and then outputs the decoded frame as an output frame.

The noise removing unit 300 includes, as structural elements, a coding type identifying unit 301, a filter processing unit 302, an output frame storing memory 303, a coding type storing memory 304 and a noise removing strength determination unit 305.

The coding type identifying unit 301 is a processing unit which identifies the coding type of a current area for post filtering. The coding type identifying unit 301 also identifies: the coding type of an area which is included in a picture temporally continuous to a current picture and which is colocated with the current area of the current picture; or the coding type of an area spatially adjacent to the current area. In this embodiment, the coding type of a current block transferred from the variable-length decoding unit 201 is identified. Further, the coding type of a block which is stored in the coding type storing memory 304, included in a frame temporally continuous from the current picture and colocated with the current block is identified. Further, the coding type of a block spatially adjacent to the current block is identified. Then, information regarding a coding type of each of the frames is transferred to the noise removing strength determination unit 305. Further, the coding type of the current block is stored in the coding type storing memory 304. Here, the current block is a block to be an object of post filtering.

The filter processing unit 302 is a processing unit which performs post filtering for removing noise. As the noise removing strength W increases, the filter processing unit 302 strengthens smoothing, so that the consistency of image quality in a temporal direction increases. Filtering for increasing temporal continuity is performed on the current block of the decoded frame, by using: the immediately preceding output frame which is stored in the output frame storing memory 303; the decoded frame which is transferred from the video decoding unit 200; and the noise removing strength which is transferred from the noise removing strength determination unit 305. Then, copies of the decoded frame after filtering processing are generated. One copy is transferred to the output frame storing memory 303, and the other is transferred as an output frame to an external device such as a display and the like.

The output frame storing memory 303 is a storage unit which stores the output frame transferred from the filter processing unit 302.

The coding type storing memory 304 is a storage unit which temporarily stores the coding type transferred from the video decoding unit 200.

The noise removing strength determination unit 305 is a processing unit which determines the noise removing strength for post filtering, according to whether the coding type identified by the coding type identifying unit 301 is the frame coding or the field coding. In this embodiment, the noise removing strength W is determined according to the number of blocks whose coding types are identified, by the coding type identifying unit 301, as the frame coding. The noise removing strength W is determined by the following expression 2.

W=Wq×(c×Wt+(1−c)×Ws) (Expression 2)

Here, Wq is a strength determined by the quantization parameter of the current block. Wt is a strength determined by the temporal continuity of the block which is frame-coded. Ws is a strength determined by the number of the blocks, which are frame-coded, from among the blocks adjacent to the current block. The parameter c determines a ratio of Wt and Ws. These values fall within the range of 0 to 1. Note that, in the case where the noise removing strength W is 0, the filter processing unit 302 does not perform post filtering on the current block.

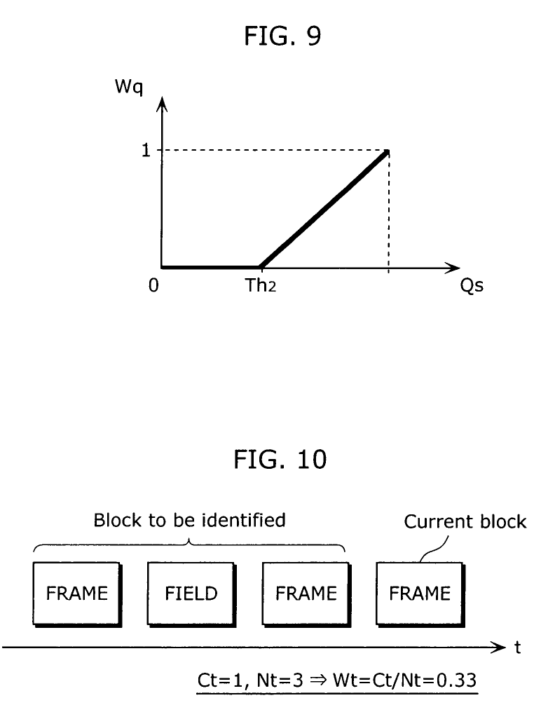

FIG. 9 shows a relation between a quantization step Qs and a strength Wq, where a horizontal axis represents the quantization step Qs which corresponds to the quantization parameter Qp and a vertical axis represents the strength Wq. In the case where the quantization step Qs is close to 0, in other words the coding is performed at a high bit rate, the smoothing processing in a temporal direction is not required since the noise is not noticeable. Accordingly, in the case where the quantization parameter Qp is less than a predetermined threshold Th₁, in other words, the corresponding quantization step Qs is less than a threshold Th₂, as shown in FIG. 9, it is possible to prevent post filtering from being performed by setting the strength Wq as 0.

Further, in the case where the quantization parameter Qp is equal to or more than the threshold Th₁, in other words, the corresponding quantization step Qs is equal to or more than the threshold Th₂, the strength Wq is set to be greater as the quantization step Qs becomes greater. With this structure, it is possible to determine the noise removing strength W in further consideration of a bit rate for coding, and to prevent unnecessary post filtering from being performed.

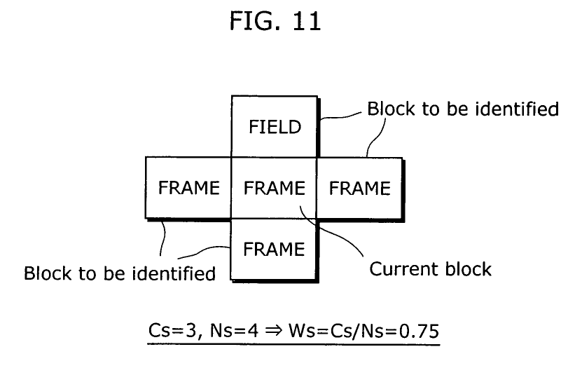

FIG. 10 shows an example of computation of the strength Wt. Wt is represented by the following expression 3.

Wt=Ct÷Nt (Expression 3)

Here, Ct is the number of pictures which include a block whose coding type is the frame coding and which are temporally continuous from the current picture. Nt is the number of blocks that the coding type identifying unit 301 identifies. In the example of FIG. 10, Wt=0.33 is obtained from Ct=1 and Nt=3. Note that, in the case where the coding type of the current block is the field coding, Wt is 0.

As described above, as more pictures including blocks whose coding types are the frame coding continue temporally, the strength Wt becomes greater. When there are a number of temporally continuous pictures including blocks whose coding types are the frame coding, there is a high probability that the coding type of the current block is also the frame coding. This means that it is possible to perform post filtering more accurately for areas in which very little motion is present.

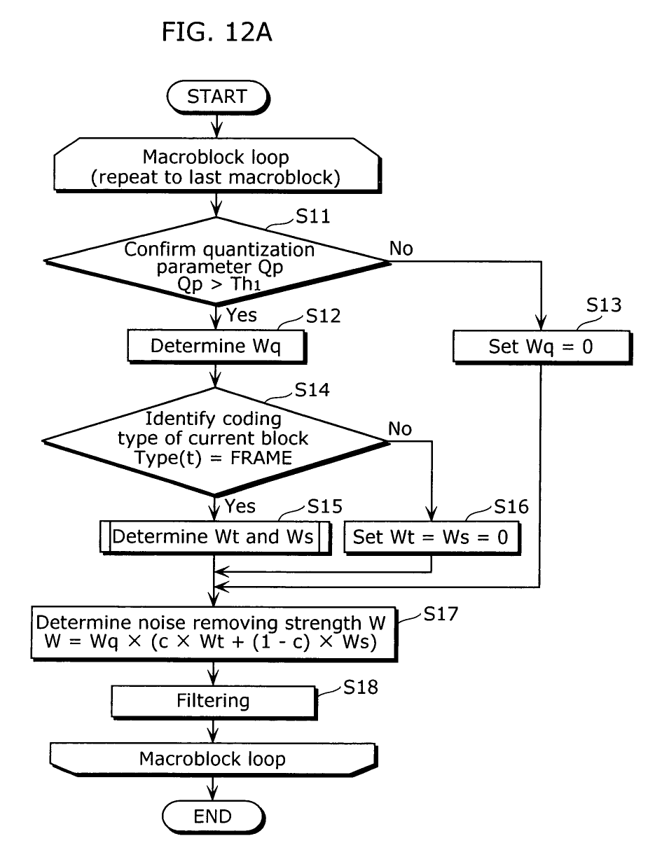

FIG. 11 shows an example of computation of Ws. Ws is represented by the following expression 4.

Ws=Cs÷Ns (Expression 4)

Here, Cs is the number of blocks whose coding types are the frame coding, among the blocks that the coding type identifying unit 301 identifies. Ns is the number of blocks that the coding type identifying unit 301 identifies. In the example of FIG. 11, Ws=0.75 is obtained from Cs=3 and Ns=4. Note that, in the case where the coding type of the current block is the field coding, Ws is 0.

As described above, as more blocks whose coding types are the frame coding are present spatially adjacent to the current block, the strength Ws becomes greater. When there are a number of blocks whose coding types are the frame coding are spatially adjacent to the current block, there is a high probability that the coding type of the current block is also the frame coding. This means that it is possible to perform post filtering more accurately for areas in which very little motion is present.

Note that, the blocks to be identified are not limited to four blocks adjacent to the current block, but eight blocks surrounding the current block may also be included.

Further, the coefficient c indicated in the expression 2 is a weighting factor which determines which of the temporal continuity or the spatial contiguity is prioritized. In other words, when c is set as 0, the noise removing strength can be determined based only on the temporal continuity. In contrast, when c is set as 1, the noise removing strength can be determined based only on spatial contiguity. As is known from the above, it is not necessarily required to confirm both the temporal continuity and the spatial contiguity, but just need to confirm any one of them.

The functional blocks of the video decoding apparatus 100 has been described above.

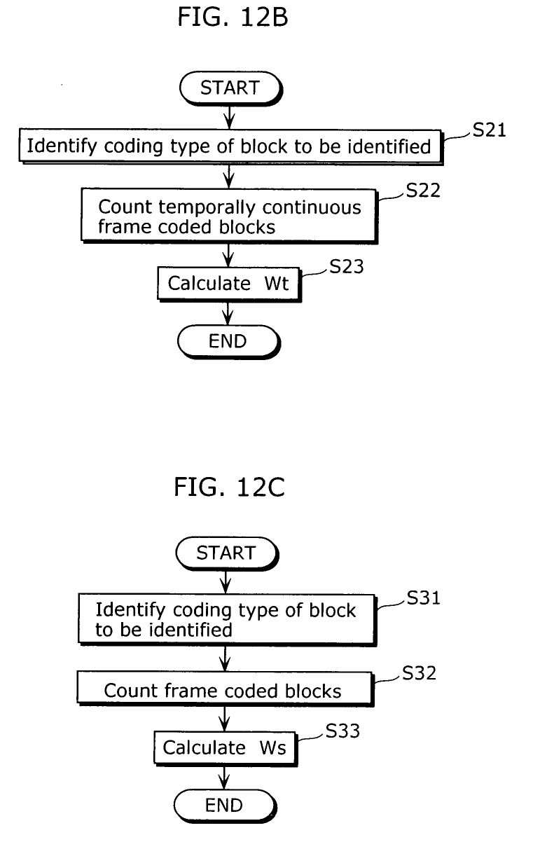

The operation of the video decoding apparatus 100 of the present invention will be described with reference to the flowchart of FIG. 12.

Note that, the flowchart shown in FIG. 12 is stored in the form of a control program on a storage device (for example, a Read Only Memory (ROM) and a flush memory, and the like) which is not shown, and is executed by a Central Processing Unit (CPU) which is also not shown.

A description as to the video decoding unit 200 is omitted since the flowchart shown in FIG. 12 is associated specifically to the operation regarding the noise removing unit 300.

The following operations are executed on a macroblock-by-macroblock basis.

The noise removing strength determination unit 305 confirms the quantization parameter Qp (S11). More specifically, the noise removing strength determination unit 305 judges whether or not the quantization parameter Qp is equal to or more than the predetermined threshold Th1.

In the case where the quantization parameter Qp is equal to or more than the threshold Th₁ (Yes in S11), the noise removing strength determination unit 305 determines the strength Wq with reference to a graph shown in FIG. 9 (S12). In the case where the quantization parameter Qp is less than the threshold Th₁ (No in S11), Wq is set as 0 (S13).

Next, the coding type identifying unit 301 identifies the coding type of the current block (S14). More specifically, the coding type identifying unit 301 judges whether the coding type of the current block is the frame coding or not. In the case where it is the frame coding (Yes in S14), the noise removing strength determination unit 305 calculates a value of Wt and Ws by using the expression 3 and the expression 4 described above (S15). In the case where it is not the frame coding (No in S14), the noise removing strength determination unit 305 sets Wt=Ws=0 (S16).

Here, the details of determining Wt and Ws (S15) are shown in FIG. 12B and FIG. 12C. Note that, either determining Wt (FIG. 12B) or determining Ws (FIG. 12C) may be preceded to the other. Or, only one of the determinations may be performed.

FIG. 12B is a flowchart showing an operation when determining the strength Wt.

First, the coding type identifying unit 301 identifies the coding type of a block colocated with the current block, in a picture temporally continuous from a current picture including the current block. Next, the noise removing strength determination unit 305 counts the number of temporally continuous pictures including a block whose coding type is the frame coding. Then, the strength Wt is determined with reference to the expression 3 (S23).

FIG. 12C is a flowchart showing an operation when determining the strength Ws.

First, the coding type identifying unit 301 identifies the coding type of a block spatially adjacent to the current block (S31). Next, the noise removing strength determination unit 305 counts the number of blocks whose coding types are the frame coding (S32). Then, the strength Ws is determined with reference to the expression 4 (S33).

As described above, after Wq, Wt and Ws are determined, the noise removing strength determination unit 305 determines the noise removing strength W with reference to the expression 2 (S17). Last, the filter processing unit 302 generates an output block o(t) by using the current decoded block i(t), an immediately preceding output block o(t−1), and the noise removing strength W (S18).

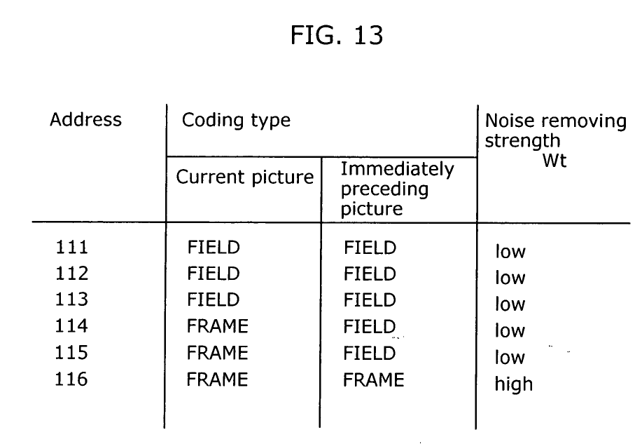

FIG. 13 shows an example of determining processing of the strength Wt from among the above described operations. In the example shown by the diagram, the coding type of each of the current picture and the immediately preceding picture is identified (Nt=1). Here, only the block corresponding to an address 116 indicates that both of the coding types for the current picture and the immediately preceding picture are the frame coding. In other words, Ct is 1. Accordingly, for the block corresponding to the address 116, the strength Wt is 1 (indicated as “high” in FIG. 13).

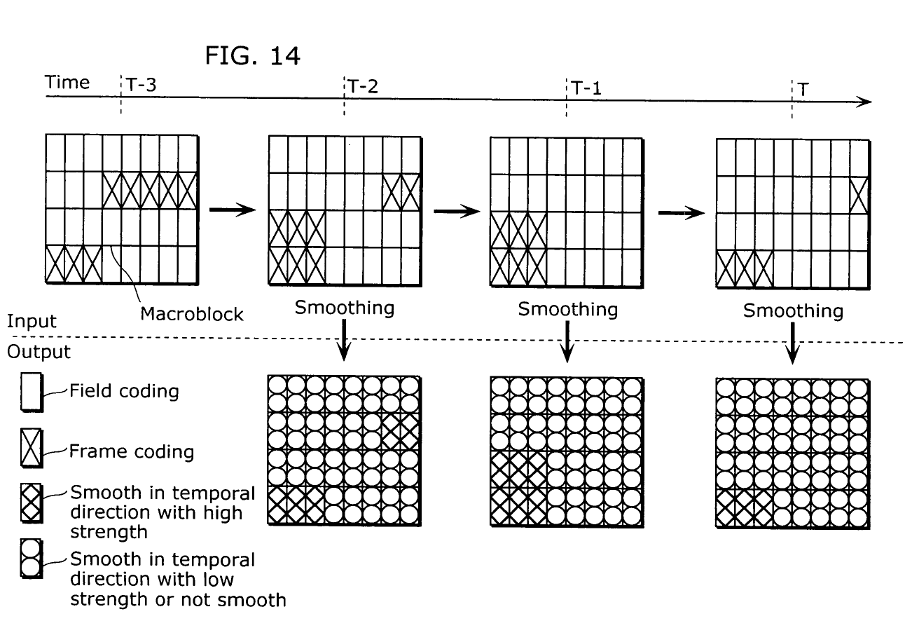

Similarly, FIG. 14 spatially shows an example of the determining processing of the strength Wt from among above described operations. The filter processing unit 302 performs smoothing in the temporal direction with higher strength for the areas where blocks whose coding types are the frame coding are continuous temporally. For other areas, smoothing in the temporal direction is performed with low strength, or not performed.

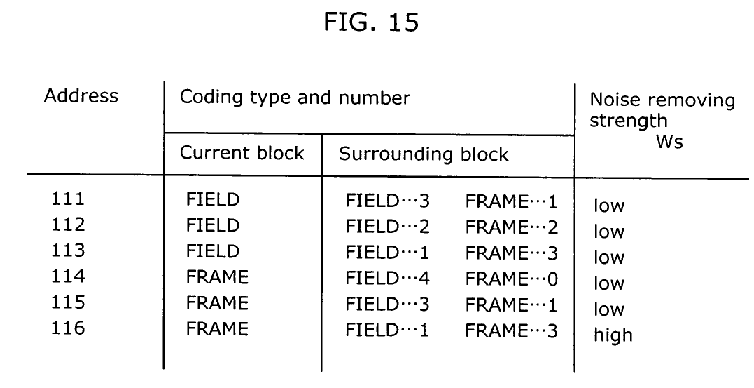

FIG. 15 shows an example of determining processing of the strength Ws from among above described operations. In the example shown by the diagram, the coding types of each of the current block which is an object for noise removal and four blocks adjacent to the current block are identified (Nt=4). It is assumed here that the strength Ws is “high” in the case where the coding types of the current block and at least two blocks from among surrounding four blocks are the frame coding.

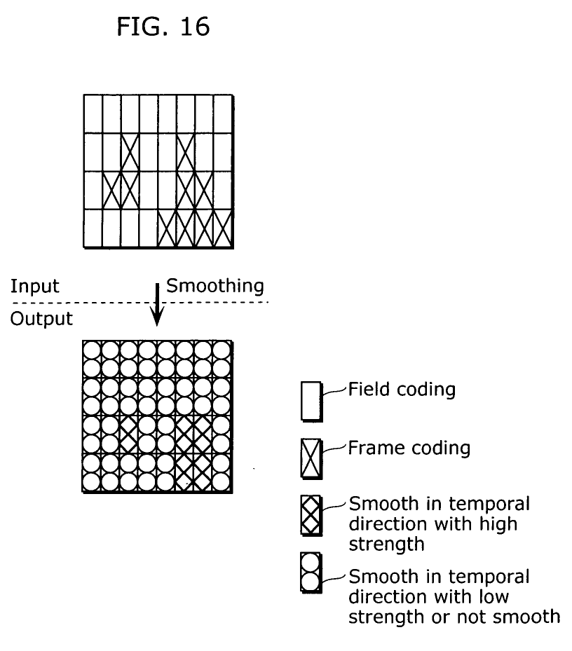

FIG. 16 spatially shows an example of FIG. 15. The filter processing unit 302 performs smoothing in the temporal direction with high strength in the case where the coding types of the current block and at least two blocks from among four blocks adjacent to the current block are the frame coding. For other areas, the smoothing in the temporal direction is performed with low strength, or not performed.

As described above, according to the video decoding apparatus and the method of the present embodiment, it is possible to increase the noise removing strength, in the case where blocks whose coding types are the frame coding are temporally continuous or spatially adjacent. Accordingly, it is possible to smooth, in the temporal direction, areas in which it appears to be certain that no motion is present. In other words, by smoothing an area in which motion is present, residual images can be prevented from occurring on images.

Although the video decoding apparatus and the method according to the present invention have been described based on the Embodiments, this invention is not limited to the Embodiments. Other forms in which various modifications that are apparent to those skilled in the art are applied to the Embodiments, or forms structured by combining structural elements of different Embodiments, are included within the scope of the present invention, unless such changes and modifications depart from the scope of the present invention.

Although decoding processing, determination processing for a noise removing strength, and post filtering are performed on a block-by-block basis as shown in FIG. 3, for example, they may be performed on a larger scale including block-by-block basis or frame-by-frame basis.

Note that, although the quantization parameter Qp is used in the video decoding apparatus and the method of the present embodiment, it is not necessarily required to be used. In the case where it is obvious that the coding has been performed with low bit rate, for example, processing amount required for calculating Wq can be reduced by applying a fixed value for Wq.

Further, it is possible to achieve the present invention as: a program which causes a computer to execute the steps of the video decoding method in the present invention; a recording medium, such as a computer-readable CD-ROM, in which the program is recorded; and information, data and a signal indicating the program. Further, the program, information, data and signal may be distributed via a communication network such as the internet.

Furthermore, part of or all of structural elements making up the video decoding apparatus described above may be made up of a single system Large Scale Integration circuit (LSI). The system LSI is a super-multifunctional LSI manufactured by integrating plural constituent parts on a single chip. More specifically, the system LSI is a computer system including a microprocessor, a ROM, a Random Access Memory (RAM), and the like. A computer program is stored on the RAM described above. The microprocessor operates according to the computer program, so that the system LSI achieves its function.

### INDUSTRIAL APPLICABILITY

The video decoding apparatus and the method of the present invention include features for decoding compressed and coded bitstreams and for reducing coding noise, and are useful for Broadcasting Satellite (BS) broadcasting and digital terrestrial broadcasting and the like, and, for example, a recorder which stores and reproduces videos captured by a surveillance camera transmitted via an IP network.

What is claimed is:

1. A video decoding apparatus which decodes a bitstream on an area-by-area basis, the area being included in a picture of an interlace format, the bitstream being coded by switching coding types between: field coding in which a top field and a bottom field are coded independently; and frame coding in which the top field and the bottom field are coded on a frame-by-frame basis, the frame consisting of the top field and the bottom field, said apparatus comprising:
a filter processing unit operable to perform post filtering that removes noise of a decoded picture;
a coding type identifying unit operable to identify a coding type of a current area on which post filtering is performed, and one of: a coding type of an area which is included in a picture temporally continuous to a current picture and which is colocated with the current area of the current picture; and a coding type of an area spatially adjacent to the current area; and
a noise removing strength determination unit operable to determine noise removing strength for the post filtering depending on whether the coding type identified by said coding type identifying unit is the frame coding or the field coding,
wherein said filter processing unit is operable to perform post filtering on the current area according to the noise removing strength.

2. The video decoding apparatus according to claim 1,
wherein: said coding type identifying unit is operable to identify the coding type of an area which is included in each of a plurality of pictures temporally continuous from the current picture and is colocated with the current area of the current picture; and
said noise removing strength determination unit is operable, in a case where the coding type of the current area is the frame coding, to set a greater noise removing strength for the post filtering, as more pictures which are temporally continuous from the current picture include areas whose coding types are identified, by said coding type identifying unit, as the frame coding.

3. The video decoding apparatus according to claim 2,
wherein said noise removing strength determination unit is operable to determine the noise removing strength in proportion to the number of pictures which are temporally continuous from the current picture and include the areas whose coding types are identified, by said coding type identifying unit, as the frame coding.

4. The video decoding apparatus according to claim 1,
wherein: said coding type identifying unit is operable to identify the coding type of each of a plurality of areas spatially adjacent to the current area; and
said noise removing strength determination unit is operable, in a case where the coding type of the current area is the frame coding, to set a greater noise removing strength for the post filtering, as there are more areas whose coding types are identified, by said coding type identifying unit, as the frame coding.

5. The video decoding apparatus according to claim 4,
wherein said noise removing strength determination unit is operable to determine the noise removing strength in proportion to the number of areas whose coding types are the frame coding, the coding types being identified by said coding type identifying unit.

6. The video decoding apparatus according to claim 1,
wherein said noise removing strength determination unit is operable, in a case where a quantization parameter for the current area is less than a predetermined threshold, to set the noise removing strength as 0; and
said filter processing unit is operable, in a case where the noise removing strength is 0, to prevent the post filtering from being performed on the current area.

7. The video decoding apparatus according to claim 6,
wherein said noise removing strength determination unit is operable, in a case where the quantization parameter is equal to or more than the threshold, to set the greater noise removing strength for the post filtering, as the quantization parameter becomes greater.

8. The video decoding apparatus according to claim 7,
wherein said noise removing strength determination unit is operable, in a case where the quantization parameter is equal to or more than the threshold, to set the noise removing strength in proportion to a quantization step which corresponds to the quantization parameter.

9. The video decoding apparatus according to claim 1,
wherein said filter processing unit is operable, as the post filtering, to perform, on the current area, smoothing in a temporal direction with higher strength, as the noise removing strength becomes greater.

10. The video decoding apparatus according to claim 1,
wherein said filter processing unit is operable to perform the post filtering on the current area in which two adjacent macroblocks are combined.

11. A video decoding method for decoding a bitstream on an area-by-area basis, the area being included in a picture of an interlace format, the bitstream being coded by switching coding types between: field coding in which a top field and a bottom field are coded independently; and frame coding in which the top field and the bottom field are coded on a frame-by-frame basis, the frame consisting of the top field and the bottom field, said method comprising:
performing post filtering for removing noise of a decoded picture;
identifying: a coding type of a current area on which post filtering is performed, and one of: a coding type of an area which is included in a picture temporally continuous to a current picture and which is colocated with the current area of the current picture; and a coding type of an area spatially adjacent to the current area; and
determining noise removing strength for the post filtering depending on whether the coding type identified by the coding type identifying unit is the frame coding or the field coding,
wherein, in said performing of post filtering, post filtering is performed on the current area according to the noise removing strength.

12. A computer program product for an video decoding apparatus which decodes a bitstream on an area-by-area basis, the area being included in a picture of an interlace format, the bitstream being coded by switching coding types between: field coding in which a top field and a bottom field are coded independently; and frame coding in which the top field and the bottom field are coded on a frame-by-frame basis, the frame consisting of the top field and the bottom field, said computer program product which, when loaded into a computer, allows a computer to execute:
performing post filtering for removing noise of a decoded picture;
identifying: a coding type of a current area on which post filtering is performed, and one of: a coding type of an area which is included in a picture temporally continuous to a current picture and which is colocated with the current area of the current picture; and a coding type of an area spatially adjacent to the current area; and
determining noise removing strength for the post filtering depending on whether the coding type identified by the coding type identifying unit is the frame coding or the field coding,
wherein, in said performing of post filtering, post filtering is performed on the current area according to the noise removing strength.

13. An integrated circuit which removes noise of a decoded picture, said integrated circuit comprising:
a filter processing unit operable to perform post filtering that removes noise of a decoded picture;
a coding type identifying unit operable to identify a coding type of a current area on which post filtering is performed, and one of: a coding type of an area which is included in a picture temporally continuous to a current picture and which is colocated with the current area of the current picture; and a coding type of an area spatially adjacent to the current area; and
a noise removing strength determination unit operable to determine noise removing strength for the post filtering depending on whether the coding type identified by said coding type identifying unit is the frame coding or the field coding,
wherein said filter processing unit is operable to perform post filtering on the current area according to the noise removing strength.
